(19) United States
(12) Patent Application Publication
(10) Pub. No.: US 2015/0291430 A1
(43) Pub. Date: Oct. 15, 2015

(54) AMBIENT SOLID-STATE MECHANO-CHEMICAL REACTIONS BETWEEN NANOSCALE SYSTEMS

(71) Applicant: William Marsh Rice University, Houston, TX (US)

(72) Inventors: Mohamad A. Kabbani, Houston, TX (US); Ahmad Toufic Kabbani, Houston, TX (US); Pulickel N. Ajayan, Houston, TX (US)

(21) Appl. No.: 14/633,867

(22) Filed: Feb. 27, 2015

Related U.S. Application Data
(60) Provisional application No. 61/979,237, filed on Apr. 14, 2014.

(51) Int. Cl. C01B 31/04

(52) U.S. Cl. CPC C01B 31/0446

(57) ABSTRACT

A method and system that provides a first nanoscale moiety with a first functionality and a second nanoscale moiety with a second functionality. The method system mixes the first and second nanoscale moieties and applies pressure to the mixture of the first and second nanoscale moieties for a period of time. The applied pressure causes the first and second functionalities to react to generate a product.

### CROSS REFERENCE TO RELATED APPLICATIONS

Pursuant to 35 U.S.C. § 119 (e), this application claims benefit of U.S. Provisional Application No. 61/979,237, filed on Apr. 14, 2014. The disclosure of the U.S. Provisional Application is incorporated herein by reference in its entirety.

### STATEMENT REGARDING FEDERALLY SPONSORED RESEARCH OR DEVELOPMENT

The invention was made with government support under Grant Numbers W911NF-10-2-0032 and FA9550-13-1-0084 awarded by the Army Research Laboratory and the Department of Defense: Air Force Office of Scientific Research, respectively. The government has certain rights in the invention.

### BACKGROUND

Chemical functionalization of nanoparticles may lead to their surface decoration with a variety of covalently attached functionalities to serve different goals such as drug delivery, cancer therapy, diagnostics and electronic devices. Carbon nanotubes (CNT) have been the subject of more than two decades of intense research. Various approaches have been used to modify their surfaces via covalent and non-covalent attachments to change both physical and chemical properties. Activation of CNTs by the incorporation of COOH on the exterior surfaces by treating them with concentrated nitric acid has been widely practiced. CNT-COOH may further be activated by acylation to form CNT-COCl, which can in turn be amidated or esterified. CNTs carrying hydroxyl groups (CNT-OH) on their surfaces have also been synthesized by alkaline hydrothermal treatment of pristine nanotubes in alkaline medium.

Many methods have been used to produce graphene, including the unzipping of nanotubes to make graphene nanoribbons. A typical chemical unzipping of CNTs makes use of oxidative techniques in concentrated acid (H₂SO₄) and post treatments with harsh reagents such as highly concentrated potassium permanganate (KMnO₄). Such processes typically involve harsh conditions to get to the final product which contains broken or unzipped graphene products.

### SUMMARY OF INVENTION

In one aspect, embodiments of the invention related to a method that includes providing a first nanoscale moiety with a first functionality and providing a second nanoscale moiety with a second functionality. The method further includes mixing the first and second nanoscale moieties and applying pressure to the mixture of the first and second nanoscale moieties for a period of time to generate a product. The applied pressure causes the first and second functionalities to react to generate the product.

In another aspect, embodiments of the invention relate to a system for producing graphene that includes a first nanoscale moiety with a first functionality, a second nanoscale moiety with a second functionality, and a container for mixing the first and second nanoscale moieties. Pressure is applied for a period of time to the mixed first and second nanoscale moieties that causes the first and second functionalities to react to generate a product.

Other aspects of the invention will be apparent from the following description and the appended claims.

### BRIEF DESCRIPTION OF DRAWINGS

FIG. 1 is a schematic in accordance with one or more embodiments of the invention.

FIG. 2 is a graph in accordance with one or more embodiments of the invention.

FIG. 3 is a graph in accordance with one or more embodiments of the invention.

FIG. 4A, 4B, and 4C show graphs in accordance with one or more embodiments of the invention.

FIG. 5A, 5B, and 5C show graphs in accordance with one or more embodiments of the invention.

FIG. 6 is a schematic in accordance with one or more embodiments of the invention.

FIG. 7 is a graph in accordance with one or more embodiments of the invention.

FIG. 8 is a histogram in accordance with one or more embodiments of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

In general, embodiments of the invention use nanotubes as a solid-state reaction template with specific chemical surface functionalities to induce direct coupling between the functional groups and concomitant breakdown of the cylindrical structure. More specifically, embodiments of the invention related to a method for unzipping of CNTs via a solid-state room temperature reaction between multiwalled CNTs (MWCNTs) containing different reactive functionalities of COOH and OH groups. In accordance with one or more embodiments of the invention, the reaction is mechano-chemically induced, initiated at room temperature in ambient air, by the grinding of two chemically variant CNT reactants, leading to graphene product formed by the unzipping of the nanotube substrates.

In general, embodiments of the invention are directed to a method and system for producing graphene. Embodiments are directed to a method of unzipping carbon nanotubes of different functionalities via a spontaneous, single pot, room temperature solid state reaction. One or more embodiments of the invention are directed to an environmentally friendly, cost effective, time effective, and clean route for the production of high quality graphene.

In accordance with one or more embodiments of the invention, a solid state hydrogen bond activation proton transfer mediated mechanism is utilized for the reaction of unzipping single or multi-walled carbon nanotubes, resulting in graphene. More specifically, in one or more embodiments of the invention, grinding, or applying pressure to, at least two carbon nanotubes (CNTs) of different reactive functionalities that are directly attached to the surface of the carbon nanotubes, for example, multi-walled carbon nanotubes (MWCNT) functionalized with -COOH and -OH, results in the unzipping of the CNTs and formation of graphene sheets whose morphology and physical appearance are different from the starting CNTs materials. Embodiments of the invention may utilize all known forms of CNT, for example, single-walled, double-walled, and/or multi-walled CNTs.

In the examples herein, grinding, or applying pressure to, at least two moieties of different reactive functionalities is accomplished using a mortar and pestle. However, one of ordinary skill in the art will appreciate that embodiments of the claimed invention are not limited to a mortar and pestle. Embodiments of the invention may utilized almost any type of machine to automatically apply the grinding force. In accordance with one or more embodiments of the invention, the surface application the force may include metal, quartz, glass, plastic, wood, or any substance that will not be compromised under the applied pressure.

In accordance with one or more embodiments of the invention, the graphene product and the mechanism of the reaction have been verified using Raman scattering, infrared (IR) and XPS spectra, scanning electron microscopy (SEM) and transmission electron microscopy (TEM) microscopic techniques, TGA/DTA thermal analysis techniques, and computer simulation techniques as described the following figures.

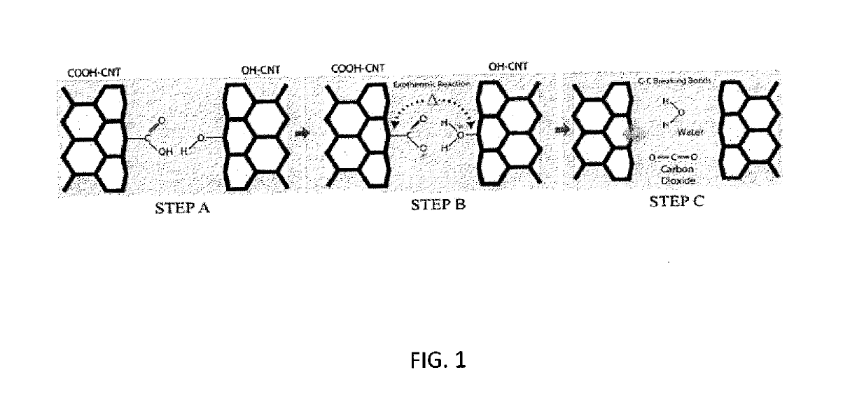

FIG. 1 is a schematic demonstrating a reaction mechanism in accordance with one or more embodiments of the invention. In Step A, CNTs are combined together through hydrogen-bond formation between the COOH and OH groups. In Step B, a fast proton transfer occurs from the carboxylic group to the hydroxyl group to form [MWCNT-OH₂]⁺ and [MWCNT-COO]⁻. In Step C, water expulsion leads to the formation of a positively charged ring carbon. With two attached groups, the positively charged carbon should be sp hybridized and linear. This places the CNT under a great deal of strain resulting from the difference between the original angle of 120° (sp²) to the intermediate angle of 180° (sp). Breaking up or unzipping of CNT relieves the CNT from such an unfavorable strain. This is compatible with the low energy grinding requirement in the unzipping process in accordance with one or more embodiments of the invention. While water expulsion during the condensation reaction will likely remove an electron pair from the CNT ring carbon, decarboxylation may add an electron pair to the ring carbon and leads to the formation of a negatively charged carbon. The presence of the lone pair results in a bond angle squeeze stress that propagates along the CNT surface and leads to unzipping in accordance with embodiments of the invention.

For example, while grinding equal weights of MWCNT-COOH and MWCNT-OH decorated with 1.41 and 0.46% by weight of COOH and OH, respectively, a sheet-like lustrous material is formed as verified by electron microscopy in accordance with embodiments of the invention. The product appears visibly different from the starting MWCNTs materials to the eye. Characterization of the material using different microscopic and spectroscopic methods shows that the product includes graphene or partially opened CNTs, formed via the unzipping of the MWCNT reactants.

In accordance with one or more embodiments of the invention, the unzipping reaction may be represented by equation (1).

MWCNT-COOH+MWCNT-OH−G→G′+H₂O+CO₂ (1)

Where G and G′ represent the graphenes originating from the carboxylic and hydroxyl MWCNT functionalized MWCNTs.

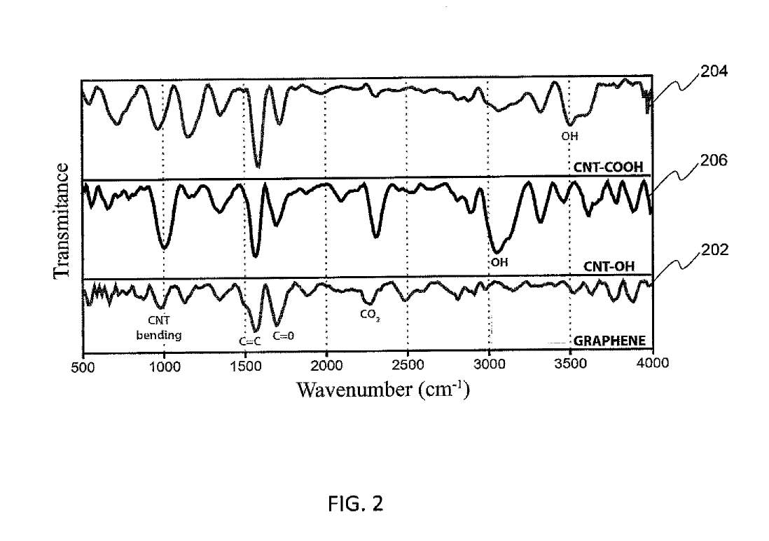

FIG. 2 demonstrates Attenuated Total Reflectance-Infrared (ATR-IR) spectrums in accordance with one or more embodiments of the invention. ATR-IR spectroscopy of the solid state reaction graphene product after grinding 202 as compared with MWCNTs starting material MWCNT-COOH 204 and MWCNT-OH 206. Formation of water in the unzipping process is confirmed by the absence of the COOH/OH stretch band in the 3600-2800 cm⁻¹ region of the graphene product. Thin sheets of the graphene product are formed due to the unzipping of the MWCNTs in accordance with one or more embodiments of the invention. These sheets may be covered and surrounded with traces of unreacted CNTs.

As previously noted, ATR-IR of the solid-state reaction product 202 reveals almost complete absence of the COOH/O—H stretch in the region 3600-2800 cm⁻¹, in agreement with water formation during the reaction. Also, the intensity of the carbonyl band due to either carboxylic group or keto-enol tautomer in the CNT-OH diminishes significantly with the appearance of the asymmetric adsorbed CO₂ mode band at 2345 cm⁻¹. Compatible with these conclusions is the decrease in the bending IR mode feature of the CNTs at 868 cm⁻¹ in the graphene product. Any residual intensity may be attributed to the unreacted CNTs.

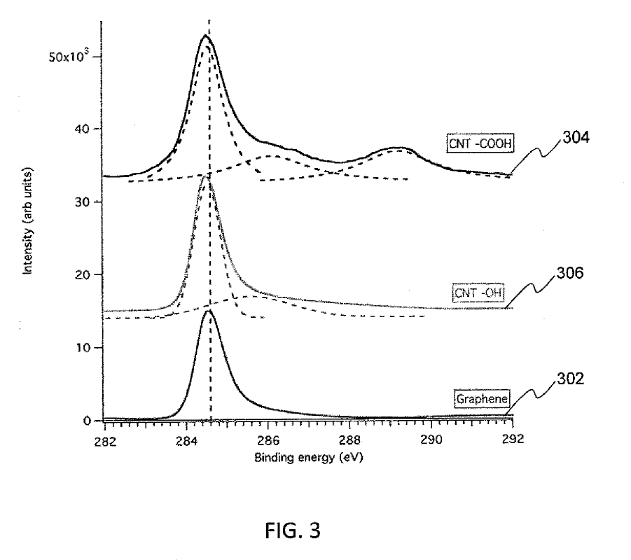

FIG. 3 demonstrates XPS spectrums in accordance with one or more embodiments of the invention. FIG. 3 demonstrates high resolution Cls XPS spectrum of the solid state reaction graphene product obtained after grinding 302 as compared with MWCNTs starting materials CNT-COOH 304 and CNT-OH 306. In the Cls XPS of the MWCNTs shown in FIG. 3, the signal at 289.2 eV in 304 corresponds to the carboxyl group while the shoulders at 286.1 eV and 285.6 eV in 304 and 306 correspond to the C-O peak in MWCNT-COOH and MWCNT-OH, respectively. Upon grinding, these signals diminish in intensity and the most dominant peak becomes that of C=C at 284.8 eV, as seen in 302. This is further evidence in favor of a condensation reaction taking place between the COOH and OH.

In addition, according to XPS, oxygen content drops from 0.715% in the unreacted mixture to 0.28% in the desorbed solid product. For example, if the percentage of oxygen (%O) of MWCNT-COOH is normalized to 1.0, the %O of MWCNT-OH is 0.430, the %O in the unreactive mixture 0.715, and the %O of the solid product after heating to a constant weight at 110° C. is 0.280 (as determined by the XPS measurement). The calculation of oxygen content may be determined after a 60% yield reaction=0.715 x 0.4=0.286. The amount of reacted oxygen due to simple esterification reaction =0.5/2=0.25%. In addition, the observed amount of reacted oxygen may be determined by 0.715-0.280=0.435%. This represents approximatinly 0.6×0.715=0.429%, or an expected 60% yield oxygen reacted.

Water condensed in a simple esterification reaction comes from the OH of the carboxylic acid and constitutes half the oxygen of the carboxylic group. The fact that the loss of oxygen (0.715-0.28=0.435%) is larger than that expected on the basis of pure esterification reaction is in agreement with a graphene, H₂O and CO₂ reaction, the yield of which, in this example is ˜61%. In accordance with embodiments of the invention, the %O considerations are compatible with the IR data shown in FIG. 2.

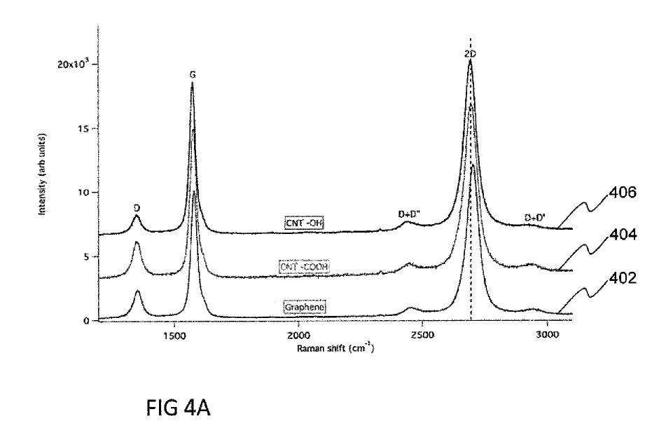

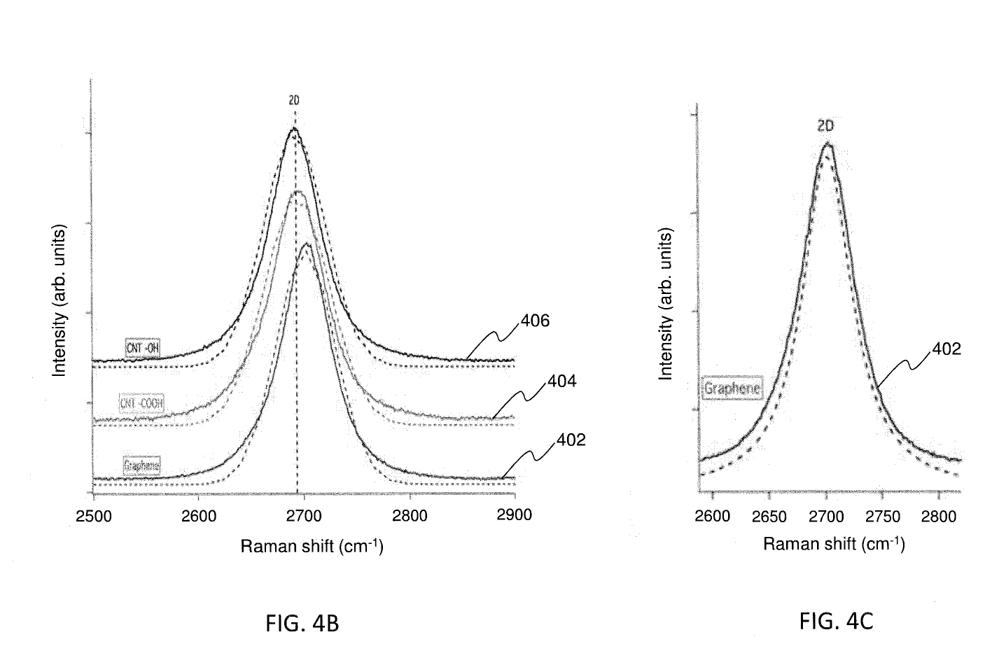

FIGS. 4A, 4B, and 4C are Raman spectrums in accordance with one or more embodiments of the invention. FIG. 4A is Raman spectra of the solid state reaction mixture after grinding 402 as compared with MWCNTs starting material MWCNT-COOH 404 and MWCNT-OH 406 in accordance with one or more embodiments of the invention. FIG. 4B is a 2D-band spectrum of the product 402 as compared to those in the CNTs starting materials 404 and 406. FIG. 4C is a single-Lorentzian fit of the 2D band in the product 402. All the bands in the product 402 are upshifted relative to the reacting MWCNTs 404 and 406 while the second-order Raman band (2D) appearing at 2705 cm⁻¹ is downshifted as compared to the graphite band at 2714 cm^{-l}as demonstrated in FIG. 4B. The 2D band in the product was fitted by a sharp and symmetric Lorentzian peak in agreement with a few layer graphene-like product as demonstrated in FIG. 4C. The observations of lower 2D wavenumbers relative to graphite, smaller I_{D}/I_{G} ratio (0.201) and larger I_{2D}/I_{G} ratio (1.21) obtained for the reaction product 402 demonstrate the formation of few layer graphene materials in accordance with one or more embodiments of the invention.

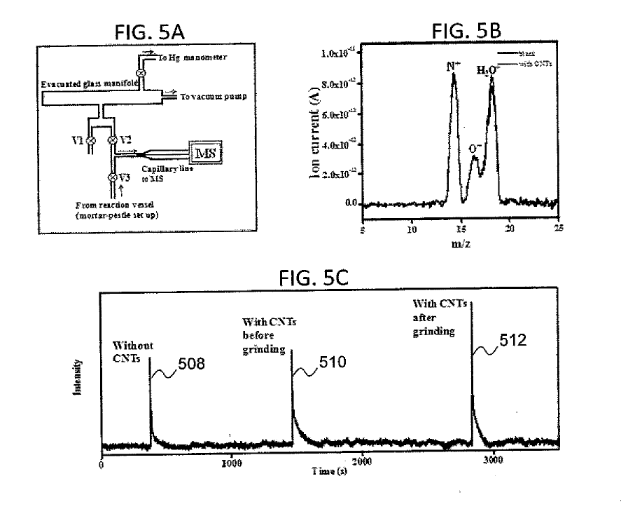

FIGS. 5A, 5B, and 5C demonstrate mass spectrometric detection of water using Ion current vs. time plots for H₂O⁺ in accordance with one or more embodiments of the invention. FIG. 4A is a schematic of the experimental set up for the online mass spectrometric detection of water during the solid state condensation reaction between MWCNTs. FIG. 4B is mass spectra showing the changes in N⁺, O⁺ and H₂O⁺ intensities for the blank and the sample after grinding. FIG. 4C is an ion current vs. time plots for H₂O⁺ for a blank wihout MWCNTs 508, and with MWCNTs before grinding 510 and after grinding 512.

As shown in FIGS. 5A, 5B, and 5C, water formation during the solid-state reaction between the MWCNTs has been established through in-situ mass spectrometric study of the reaction products. Briefly, the example shown in FIGS. 5A, 5B, and 5C involved conducting the solid state reaction in an enclosed mortar and pestle and sampling the gases formed directly with a quadruple mass spectrometer, in the mass range of 1-300 amu using the set shown in FIG. 5A.

A blank measurement was done without any CNTs 508 in order to estimate the contribution from atmospheric gases and moisture. MWCNT-COOH and MWCNT-OH (1:1 ratio by weight) 510 were taken in the mortar and ground using a pestle and then the gases in the reaction vessel were allowed into the mass spectrometer inlet by opening a valve. Intensity of the peak at m/z 18 (due to H₂O⁺) increased significantly as shown in FIG. 5B, to two times higher than in the blank experiment.

In accordance with one or more embodiments of the invention, the corresponding mass spectral (intensity vs. m/z) data shown in FIG. 5C, shows that only H₂O⁺ intensity increased after the reaction while N⁺ and O⁺ intensities remained the same. In order to check whether this increase is due to the desorption of water vapor that was adsorbed on MWCNTs, the control experiment was carried out. Initially a blank was measured without MWCNTs as shown in 508. Then MWCNTs were kept in the mortar without grinding for 2 minutes and gases inside were sampled (after the evacuation step) as shown in 510. Intensities of N⁺, O⁺ and H₂O⁺ were almost the same as that of the blank 508. After the mixture of MWCNTs were ground for 20 minutes, mass spectral measurement clearly showed an increase in intensity of only H₂O⁺. When the OH and COOH functionalized MWCNTs were separately ground and no increase in H₂O⁺ was detected. This demonstrates that H₂O desorption from MWNTs is not the reason for increased H₂O³⁰ intensity. No increase in CO₂ intensity was seen as it appears to be adsorbed effectively on the resulting graphene.

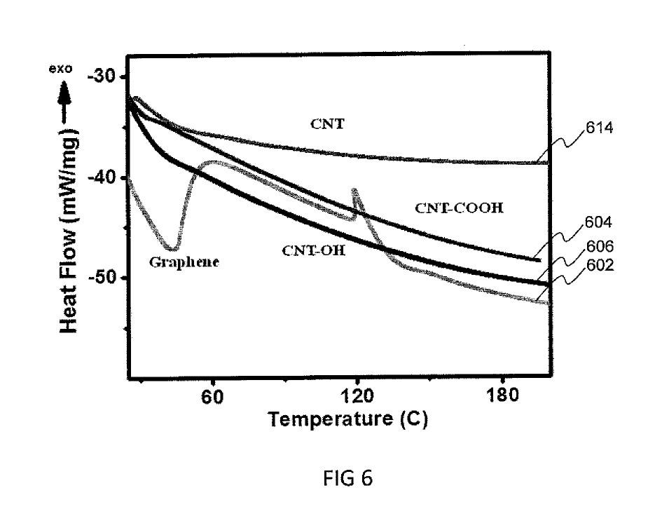

FIG. 6 is a graph demonstrating differential thermal analysis (DTA) in accordance with one or more embodiments of the invention. The DTA of individual unmixed CNTs 614 and that of the graphene product 602. The DTA of CNT-OH 606 and CNT-COOG 604 are also shown in FIG. 6. In 602 of FIG. 6, the first peak is due to desorption of CO₂ while the second is due to desorption of water. Reproducibility of the results was confirmed by repeating these experiments several times with various ratios of the two MWCNT varieties. The decrease in the oxygen content, as revealed from the XPS measurements shown in FIG. 3, is supported by our mass spectrometric detection of water. Hence, the in-situ mass spectrometric experiments unambiguously give evidence for the solid state condensation reaction between —COOH and —OH groups of the functionalized MWCNTs. This is further supported by the DTA at different temperatures shown in FIG. 6, which gave the two distinct peaks. The more intense peak occurs at −50° C., while the less intense one occurs at −110° C. The peak at 110° C. is due to the desorption of water. As the energy evolved at lower temperature is appreciably higher than that due to desorption of water and in light of the strong of CO₂ /graphene adsorption, the peak at −50° C. is assigned to the desorption of CO₂. In accordance with one or more embodiments of the invention, these conclusions are compatible with the IR and XPS data presented previously with regard to FIGS. 2-5C.

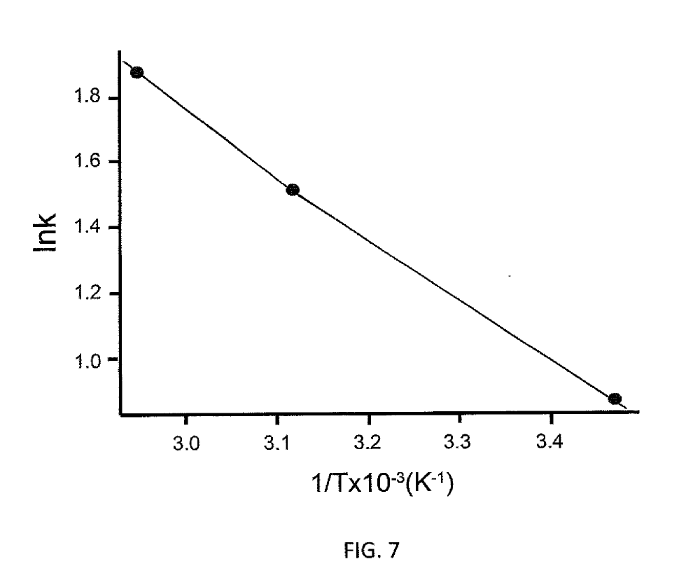

FIG. 7 is an Arrhenius plot in accordance with one or more embodiments of the invention. The Arrhenius plot displays the logarithm of kinetic constants (ln(k)) plotted against inverse temperature l/T. As known, Arrhenius plots are used to analyze the effect of temperature on the rates of chemical reactions. For a single rate-limited thermally activated process, an Arrhenius plot gives a straight line as shown in FIG. 7, from which the activation energy may be determined. For example, in the Arrhenius plot shown in FIG. 7, ln(k) vs. l/T demonstrates a slope =−R/E_{act}=−2.00×10³. Kinetics of the reaction and product formation were determined by measuring the intensity of the 2D Raman band of the graphene product at different temperatures. The Arrhenius plot of FIG. 7 demonstrates an activation energy of 16.63 kJ/mol, a value consistent with the activation energies reported for solid-state hydrogen-bond mediated proton-transfer reactions between organic compounds such as carboxylic acid/phenol and carboxylic acid/amine combination.

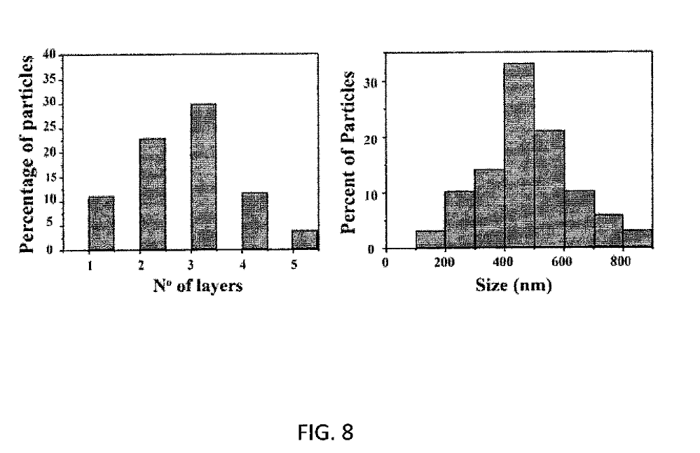

FIG. 8 is a histogram in accordance with one or more embodiments of the invention. Although the amount of graphene-like material was negligible in these samples due to the specific reaction conditions, the product powder showed predominantly sheet-like structures along with residues of partially reacted nanotubes. The image analyses of SEM images (not shown) were used to calculate the amount of 2D sheets present and the residue of carbon nanotubes. The sheets are randomly distributed with a range of sizes with approximately 20% being unreacted CNT. In order to further confirm the opening of CNTs and the quality of the graphene-like product, transmission electron microscopy (TEM) imaging was also performed. TEM analysis showed CNTs to be multiwalled with an average diameter of 20 nm. The electron microscopy also showed large sheets of graphene-like material with smooth edges, some with a multilayer structure. It is possible that the graphene flakes formed during the reaction may have coalesced to form larger multilayer graphitic sheets. For further confirmation of such a structure, Selected Area Diffraction (SAD), was performed in conjunction with the SEM analysis (not shown). The result demonstrated hexagonal lattices associated with graphene stacks in accordance with one or more embodiments of the invention. The histograms shown in FIG. 8 demonstrate the size and number of layers formed due to coalescing of the produced graphene as analyzed by electron microscopy. As such, one of ordinary skill in the art will appreciate that embodiments of the claimed invention may not only be used to fabricate single layers of graphene for applications, but the above-disclosed coalescence of graphene layers may also be used.

In one or more embodiments, the diffusion-controlled solid-state reaction may make the assembly and incorporation of graphene in computers /transistors electronics feasible, smooth, direct and tunable. The solid state synthesis of graphene may open a door for better implementations of different applications such as super capacitors, batteries, solar devices and aerogels. With a wide spectrum of doped CNTs as starting materials, embodiments may produce novel nanomaterials with promising mechanical, electrical, and thermal properties.

In accordance with one or more embodiments of the invention, as CNTs are not simple molecular systems, the stoichiometry of the solid state reaction may result in some residual unreacted CNTs. However, one of ordinary skill in the art will appreciate that the yield may be determined by the reaction conditions, such as time grinding. In one or more embodiments, the yield of graphene may be greater than 80%, or even greater than 90%. Embodiments of the invention may avoid lengthy procedures of heating and using chemicals where quality of graphene may be adversely affected. In one or more embodiments, a single pot reaction at room temperature is utilized in which carbon nanotubes of different functionalities are mixed and pressure is applied.

In accordance with embodiments of the invention, the ambient solid-state mechano-chemical reactions (MCR) disclosed herein may be considered with nanoscale moieties other than CNTs, such as functionalized fullerenes which have greater contact of interaction, functionalized graphene ribbons, graphene oxide, graphite oxide. Also, embodiments of the invention may also include reactions using metal nanoparticles and metal oxides nanoparticles.

In accordance with one or more embodiments of the invention, other MCRs between CNTs may include CNT-COCl/OH, and CNT-COCl/amine functionalities. In accordance with one or more embodiments of the invention, MCRs between CNTs obey the laws of chemical reactivity, for example, the acyl chloride CNT gave quantitative reaction as compared to a 60% yield with the CNT-COOH/OH reaction. The nature of the nanotube, for example single or multiple walled, and its differed helical structures may also be utilized depending on the desired graphene characteristics in the final product. The different combination of functionalities may also be utilized with doped CNTs, for example, N or B doped, in accordance with one or more embodiments of the invention. Embodiments of the invention may provide a wide spectrum of new graphene products with enhanced mechanical and electrical properties that may be exploited in an abundance of new applications.

In one or more embodiments, as noted above, different reactive functionalities directly attached to the surface of the tubes may be correlated with the properties of the graphene product. Other variations may include variation in size, multiplicity of the walls of nanotubes, and doping effects. In addition, the distance of the functionalities from the surface of the nanotubes may be used to control the effectiveness of the rupture of the CNTs walls.

Embodiments of the invention may provide high quality graphene for use in solar cells, display screens, electronics, biological and electrical sensors, batteries, super capacitors, and other applications involving graphene.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method comprising:
providing a first nanoscale moiety with a first functionality;
providing a second nanoscale moiety with a second functionality;
mixing the first and second nanoscale moieties; and
applying pressure to the mixture of the first and second nanoscale moieties for a period of time to generate a product,
wherein applying pressure causes the first and second functionalities to react.

2. The method of claim 1, wherein the first and second nanoscale moiety are carbon nanotubes.

3. The method of claim 2, wherein the first nanoscale moiety is doped with one selected from: boron or nitrogen.

4. The method of claim 1, where the first functionality is an —OH group and the second functionality is a —COOH group.

5. The method of claim 1, wherein the first functionality is an acylchloride group and the second functionality is a —OH group.

6. The method of claim 1, wherein the first functionality is an acylchloride group and the second functionality is an amine group.

7. The method of claim 1, wherein the first nanoscale moiety is a multi-walled carbon nanotube.

8. The method of claim 1, wherein the first nanoscale moiety is a single walled carbon nanotube.

9. The method of claim 1, wherein the product comprises graphene.

10. The method of claim 9, wherein the product comprises at least 80% graphene.

11. A system for producing graphene, the system comprising:
a first nanoscale moiety with a first functionality;
a second nanoscale moiety with a second functionality; and
a container for mixing the first and second nanoscale moieties,
wherein applying pressure for a period of time to the first and second nanoscale moieties causes the first and second functionalities to react to generate a product.

12. The system of claim 11, wherein the first and second nanoscale moiety are carbon nanotubes.

13. The system of claim 12, wherein the first nanoscale moiety is doped with one selected from: boron or nitrogen.

14. The system of claim 11, where the first functionality is an —OH group and the second functionality is a —COOH group.

15. The system of claim 11, wherein the first functionality is an acylchloride group and the second functionality is a —OH group.

16. The system of claim 11, wherein the first functionality is an acylchloride group and the second functionality is an amine group.

17. The system of claim 11, wherein the first nanoscale moiety is a multi-walled carbon nanotube.

18. The system of claim 11, wherein the first nanoscale moiety is a single walled carbon nanotube.

19. The system of claim 11, wherein the product comprises graphene.

20. The system of claim 19, wherein the product is at least 80% graphene.
